(19) United States
(12) Patent Application Publication
(10) Pub. No.: US 2019/0332970 A1
(43) Pub. Date: Oct. 31, 2019

(54) COMPONENT RELEASING METHOD, COMPONENT CREATION METHOD, AND GRAPHIC MACHINE LEARNING ALGORITHM PLATFORM

(71) Applicant: ALIBABA GROUP HOLDING LIMITED, George Town (KY)

(72) Inventors: Zongxiong LEI, Hangzhou (CN); Bo LI, Hangzhou (CN)

(73) Assignee: ALIBABA GROUP HOLDING LIMITED

(21) Appl. No.: 16/505,617

(22) Filed: Jul. 8, 2019

Related U.S. Application Data
(63) Continuation of application No. PCT/CN2017/118433, filed on Dec. 26, 2017.

(30) Foreign Application Priority Data
Jan. 6, 2017 (CN) 201710011143.6

(51) Int. Cl. G06N 20/00

(52) U.S. Cl. CPC G06N 20/00

(57) ABSTRACT

Embodiments of the present disclosure provide a component releasing method and a component creation method. The component releasing method comprises after receiving an instruction to release a functional model as a new first component, determining an input end and an output end of the new first component according to the connection relationship of second components in the functional model, determining unique identifiers of mandatory parameters of the second components in the functional model. The unique identifiers are used for the new first component to identify values of the mandatory parameters during running of the first component. The method also comprises releasing the functional model as the new first component. The component creation method comprises after receiving a component creation instruction, creating, by a graphic machine learning platform, a first component according to afunctional model. A mandatory parameter of each second component in the first component has a unique identifier, and the unique identifier is used for the first component to identify a value of the mandatory parameter during running of the first component.

### CROSS-REFERENCE TO RELATED APPLICATION

The present disclosure claims the benefits of priority to International Application No. PCT/CN2017/118433 filed on Dec. 26, 2017, which claims priority to Chinese Patent Application No. 201710011143.6, filed on Jan. 6, 2017, both of which are incorporated herein by reference in their entireties.

### TECHNICAL FIELD

The present disclosure relates to the field of electronic information, and in particular, to a component release method, a graphic machine learning algorithm platform-based component building method, and a graphic machine learning algorithm platform.

### BACKGROUND

A graphic machine learning algorithm platform is a user interaction platform and can provide a modeling function to users. Components are basic units of the graphic machine learning algorithm platform. A user organizes components into an ordered process to establish a model having a certain function. For example, FIG. 1 shows a model established by a user for analyzing user churn data. In the model, an elliptical icon represents a component, and the name of the elliptical icon, such as “splitting-1” and “random forest”, represents the algorithm run by the component. The user can establish a model for analyzing user churn data by connecting these components into an ordered process using arrows.

However, if the user needs to use the function again, the user needs to build the functional model again.

### SUMMARY

Embodiments of the present disclosure provide a component releasing method. The method can comprise: after receiving an instruction to release a functional model as a new first component, determining an input end and an output end of the new first component according to the connection relationship of second components in the functional model, determining unique identifiers of mandatory parameters of the second components in the functional model. The unique identifiers are used for the new first component to identify values of the mandatory parameters during running of the first component. The method also comprises releasing the functional model as the new first component.

Embodiments of the present disclosure also provide a component creation method. The method can comprise: after receiving a component creation instruction, creating, by a graphic machine learning platform, a first component according to afunctional model. A mandatory parameter of each component in the first component has a unique identifier, and the unique identifier is used for the first component to identify a value of the mandatory parameter during running of the first component.

Embodiments of the present disclosure also provide an apparatus for component releasing. The apparatus can comprise a memory storing a set of instructions, and one or more processors configured to execute the set of instructions to cause the apparatus to perform: after receiving an instruction to release a functional model as a new first component, determining an input end and an output end of the new first component according to the connection relationship of second components in the functional model, determining unique identifiers of mandatory parameters of the second components in the functional model. The unique identifiers are used for the new first component to identify values of the mandatory parameters during running of the first component. The method also comprises releasing the functional model as the new first component.

Embodiments of the present disclosure also provide an apparatus for component creation. The apparatus can comprise a memory storing a set of instructions, and one or more processors configured to execute the set of instructions to cause the apparatus to perform: after receiving a component creation instruction, creating, by a graphic machine learning platform, a first component according to afunctional model. A mandatory parameter of each component in the first component has a unique identifier, and the unique identifier is used for the first component to identify a value of the mandatory parameter during running of the first component.

Embodiments of the present disclosure also provide a non-transitory computer readable medium that stores a set of instructions that is executable by at least one processor of a device to cause the device to perform a component releasing method. The method can comprise: after receiving an instruction to release a functional model as a new first component, determining an input end and an output end of the new first component according to the connection relationship of second components in the functional model, determining unique identifiers of mandatory parameters of the second components in the functional model. The unique identifiers are used for the new first component to identify values of the mandatory parameters during running of the first component. The method also comprises releasing the functional model as the new first component.

Embodiments of the present disclosure also provide a non-transitory computer readable medium that stores a set of instructions that is executable by at least one processor of a device to cause the device to perform a component creation method. The method can comprise: after receiving a component creation instruction, creating, by a graphic machine learning platform, a first component according to afunctional model. A mandatory parameter of each component in the first component has a unique identifier, and the unique identifier is used for the first component to identify a value of the mandatory parameter during running of the first component.

### BRIEF DESCRIPTION OF THE DRAWINGS

The accompanying drawings described herein are used to provide further understanding of the present disclosure and constitute a part of the present disclosure. Exemplary embodiments of the present disclosure and descriptions of the exemplary embodiments are used to explain the present disclosure and are not intended to constitute inappropriate limitations to the present disclosure. In the accompanying drawings:

FIG. 1 is a schematic diagram of an exemplary model built by a user for analyzing user churn data.

FIG. 2 is a flowchart of an exemplary component release method, consistent with embodiments of the present disclosure.

FIG. 3 is a schematic diagram of an exemplary process of receiving an instruction by a graphic machine learning algorithm platform to release a functional model as a new component, consistent with embodiments of the present disclosure.

FIG. 4 is a schematic diagram of an exemplary comparison between a configuration process and running process of a super component, consistent with embodiments of the present disclosure.

FIG. 5 is a schematic diagram of an exemplary visual interface of a basic component, consistent with embodiments of the present disclosure.

FIG. 6 is a schematic diagram of an exemplary configuration interface of a mandatory parameter configuration control, consistent with embodiments of the present disclosure.

FIG. 7A, FIG. 7B and FIG. 7C are flowcharts of an exemplary component releasing method, consistent with embodiments of the present disclosure.

FIG. 8 is a schematic diagram of an exemplary model using a super component, consistent with embodiments of the present disclosure.

FIG. 9 is a schematic structural diagram of an exemplary graphic machine learning algorithm platform, consistent with embodiments of the present disclosure.

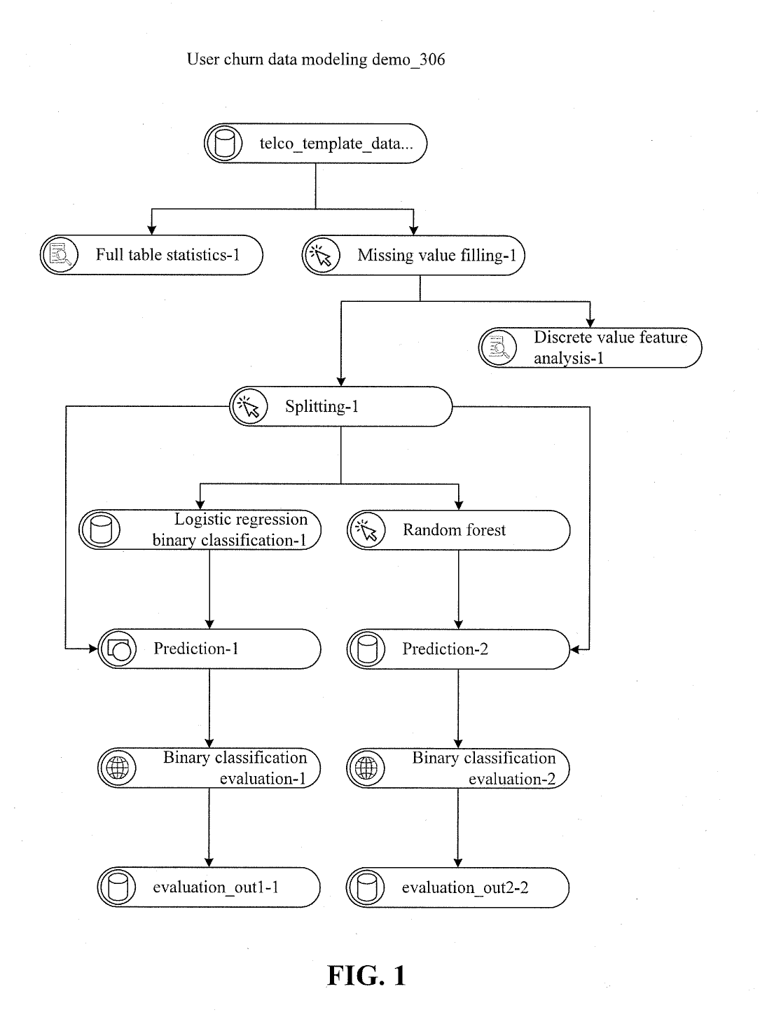

### DETAILED DESCRIPTION

To facilitate understanding of the solutions in the present disclosure, the technical solutions in some of the embodiments of the present disclosure will be described with reference to the accompanying drawings. It is appreciated that the described embodiments are merely a part of rather than all the embodiments of the present disclosure. Consistent with the present disclosure, other embodiments can be obtained without departing from the principles disclosed herein. Such embodiments shall also fall within the protection scope of the present disclosure.

When an established functional model is released or built as a new component in a graphic machine learning algorithm platform, a user can access the functionality of the functional model without the need to re-build the functional model. The component release or building method provided by the present disclosure can be applied to a graphic machine learning algorithm platform, aiming to release or build a functional model built by original components of the graphic machine learning algorithm platform as a new component. In the embodiments of this disclosure, the original components of the graphic machine learning algorithm platform are referred to as basic components, and the new component that is released or built by the basic components is referred to as a super component. A basic component can be a component implementing a single algorithm and can also be a component that is composed of multiple components each implementing a single algorithm.

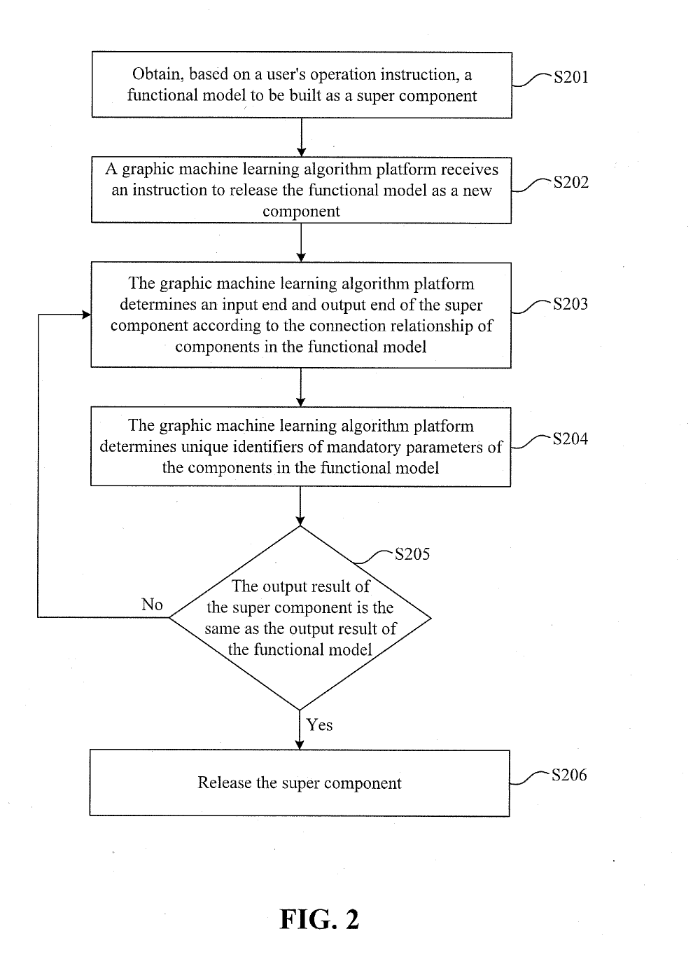

FIG. 2 is a flowchart of an exemplary component release method, consistent with embodiments of the present disclosure. The method can include the following steps.

In step S201, a graphic machine learning algorithm platform obtains, based on a user's operation instruction, a functional model to be built as a super component.

In step S202, the graphic machine learning algorithm platform receives an instruction to release the functional model as a new component.

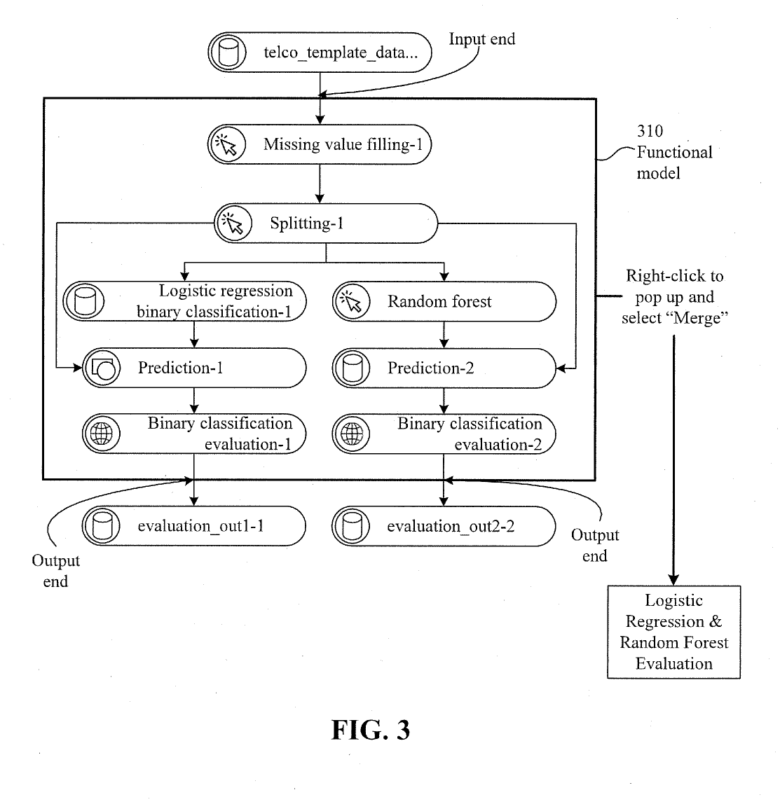

For example, as illustrated in FIG. 3, a functional model (e.g., functional model 310) can be built as a super component. The user can right click on the functional model and select “Merge” in a pop-up menu, then the graphic machine learning algorithm platform determines that an instruction to release the functional model of the selected part as a new component is received.

Further, as shown in FIG. 3, the graphic machine learning algorithm platform can also receive a name entered by the user for the super component. For example, after the user selects “Merge”, the graphic machine learning algorithm platform pops up a dialog box and receives the name “Logistic Regression & Random Forest Evaluation” entered by the user in the dialog box.

Referring back to FIG. 2, in step S203, the graphic machine learning algorithm platform determines an input end and an output end of the super component according to the connection relationship of components in the functional model.

Specifically, the connection relationship is a Connection relationship indicated by arrows in the functional model, and the graphic machine learning algorithm platform uses a connection end between the functional model and an upstream component as the input end of the super component, and a connection end between the functional model and a downstream component as the output end of the super component.

As shown in FIG. 3, the connection end between the functional model and the upstream component is a port where an arrow points at component “missing value filling-1”, and the graphic machine learning algorithm platform uses the port as the input end of the super component. The connection ends between the functional model and the downstream components are ports where the connecting arrows point from component “binary classification evaluation-1” and component “binary classification evaluation-2”, respectively, and the graphic machine learning algorithm platform uses the two ports as the output ends of the super component.

It should be noted that, when the functional model has multiple ports connected to upstream components, the multiple ports connected to the upstream components are all used as input ends of the super component. When the functional model has multiple ports connected to downstream components, the multiple ports connected to the downstream components are all used as output ends of the super component.

Referring back to FIG. 2, in step S204, the graphic machine learning algorithm platform determines unique identifiers of mandatory parameters of the components in the functional model.

The unique identifiers are used for the new component to identify values of the mandatory parameters during running of the new component.

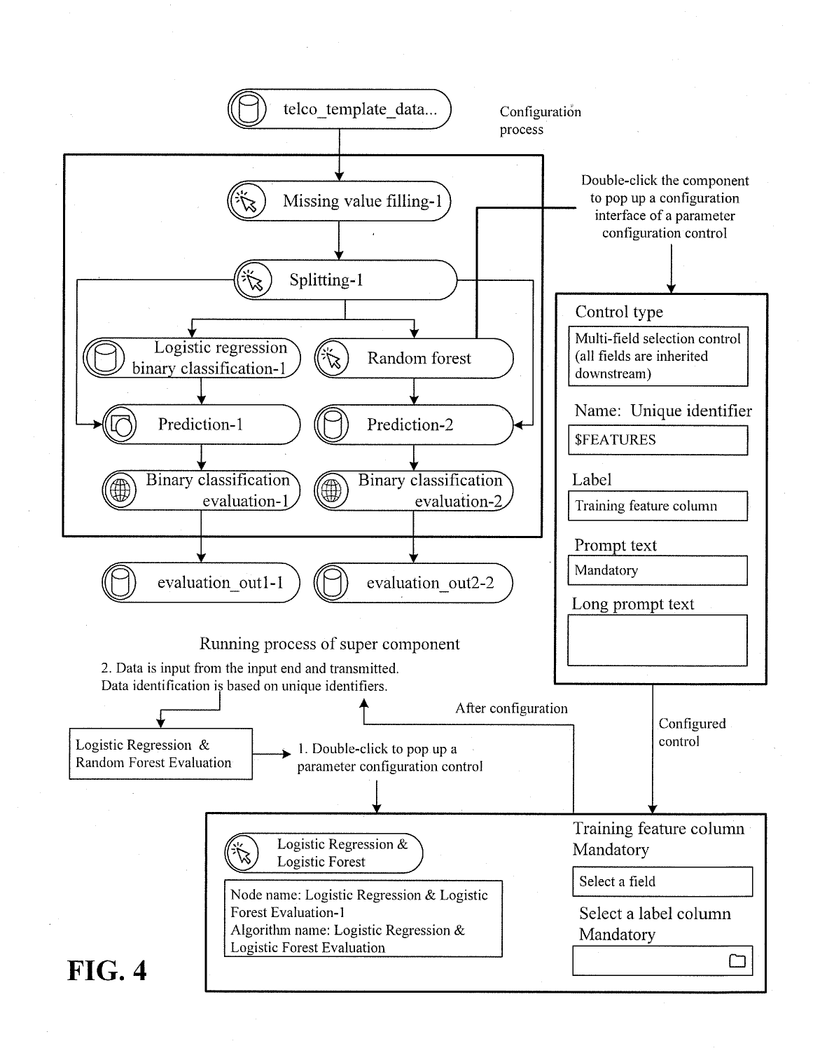

Specifically, after receiving an instruction to select a component in the functional model, the graphic machine learning algorithm platform displays a visual interface of the component and receives a unique identifier of a mandatory parameter of the component through the visual interface. For example, as shown in the configuration process in FIG. 4, after receiving an instruction of the user double-clicking component “random forest” in the functional model, the graphic machine learning algorithm platform pops up a visual interface of the component “random forest”, and the user can enter a unique identifier of a mandatory parameter of the component “random forest” on the visual interface.

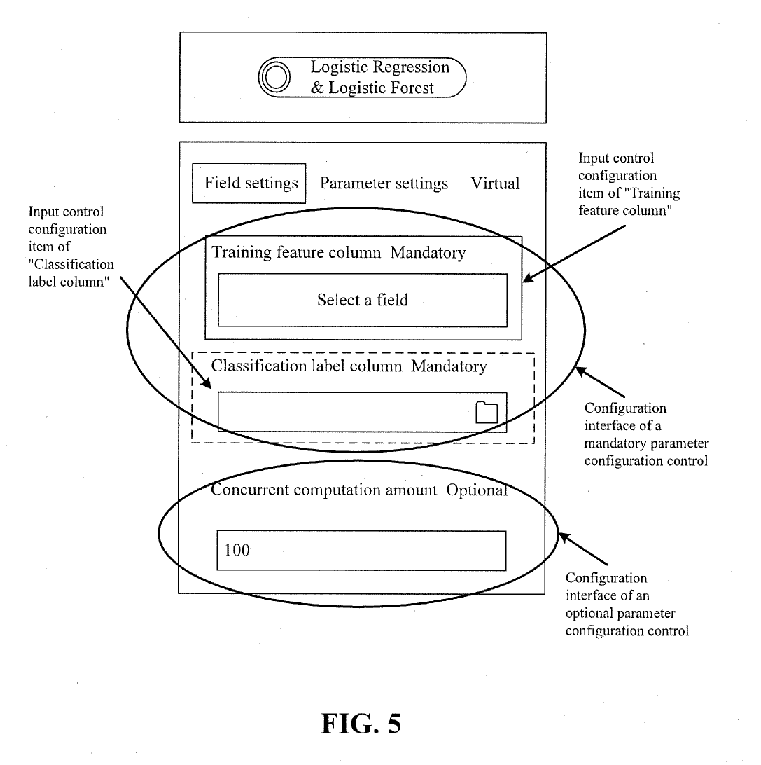

Further, as shown in FIG. 5, a visual interface of the basic component includes a configuration interface of a mandatory parameter configuration control and a configuration interface of an optional parameter configuration control, which is not shown in FIG. 4. The mandatory parameter configuration control is used for receiving a configuration instruction for a mandatory parameter during the running of the super component. The optional parameter configuration control is used for receiving a configuration instruction for an optional parameter during the running of the super component. Referring back to FIG. 4, during the running of the super component, the user configures the mandatory parameters through the mandatory parameter configuration control, for example, by entering values of the mandatory parameters. The configuration interface of the mandatory parameter configuration control in FIG. 4 is used for configuring the mandatory parameter configuration control. However, in current graphic machine learning algorithm platforms, parameter configuration controls are automatically set by a system and cannot be configured by the user.

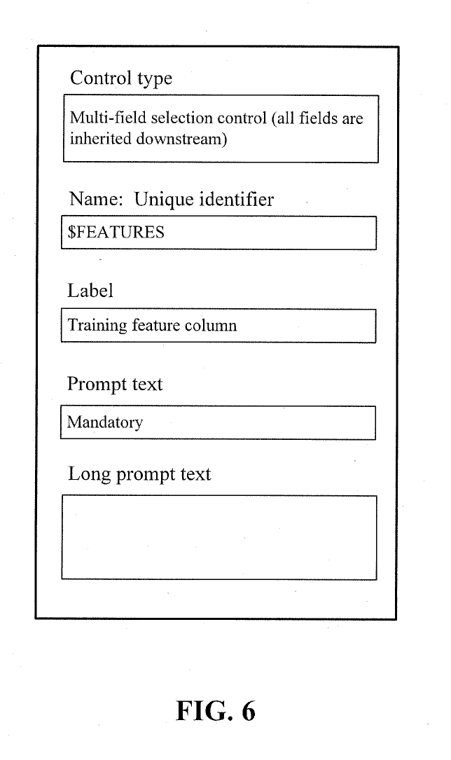

As shown in FIG. 6, the configuration interface of the mandatory parameter configuration control includes at least a unique identifier configuration item. The unique identifier configuration item is used for receiving an identifier set by the user for the mandatory parameter. The user can input, through the identifier configuration item, the identifier set for the mandatory parameter. The graphic machine learning algorithm platform uses data (including received or internally transmitted), which is identified by the super component as having the identifier, as the value of the mandatory parameter. In other words, as long as data with the identifier is identified during the running of the super component, the graphic machine learning algorithm platform uses the data as the value of the mandatory parameter. The data is used as the value of the mandatory parameter no matter which basic component in the super component identifies this data. In addition to the unique identifier configuration item, the configuration interface of the mandatory parameter configuration control may further include, but is not limited to, a control type configuration item, a control name configuration item, and a control prompt (including a prompt and a long prompt) text configuration item.

For example, FIG. 6 shows the following configuration items of a mandatory parameter “training feature column.”

Control type is a configuration item where the user can select “multi-field selection control (all fields are inherited downstream)” as a control type via a drop-down option.

Unique identifier is a configuration item where the user can enter “$FEATURE” as the unique identifier of the “training feature column” parameter.

Control name is a configuration item where the user can enter “training feature column” as the name of the control.

Prompt text is a configuration item where the user can enter “mandatory” as the prompt text for the control.

Long prompt text is a configuration item, which can be empty.

The configuration interface of the optional parameter configuration control includes the name of the optional parameter and a default value set by the graphic machine learning algorithm platform for the parameter. For example, “Concurrent computation amount” in FIG. 5 is the name of an optional parameter, and the default value of the parameter is 100. The user can accept the default value and can also modify the default value in a parameter text box.

Referring back to FIG. 2, in step S205, test data is input to the super component after completion of configuration, and the same test data is input to the functional model corresponding to the super component (i.e., the functional model that builds the super component). If the output result of the super component is the same as the output result of the functional model, step S206 is performed. If not, at least one of step S203 and step S204 is performed.

In step S206, the super component is released.

In FIG. 2, the order of step S202˜step S204 can be interchanged, and step S205 is an optional step.

The process shown in FIG. 2 can be further described as follows.

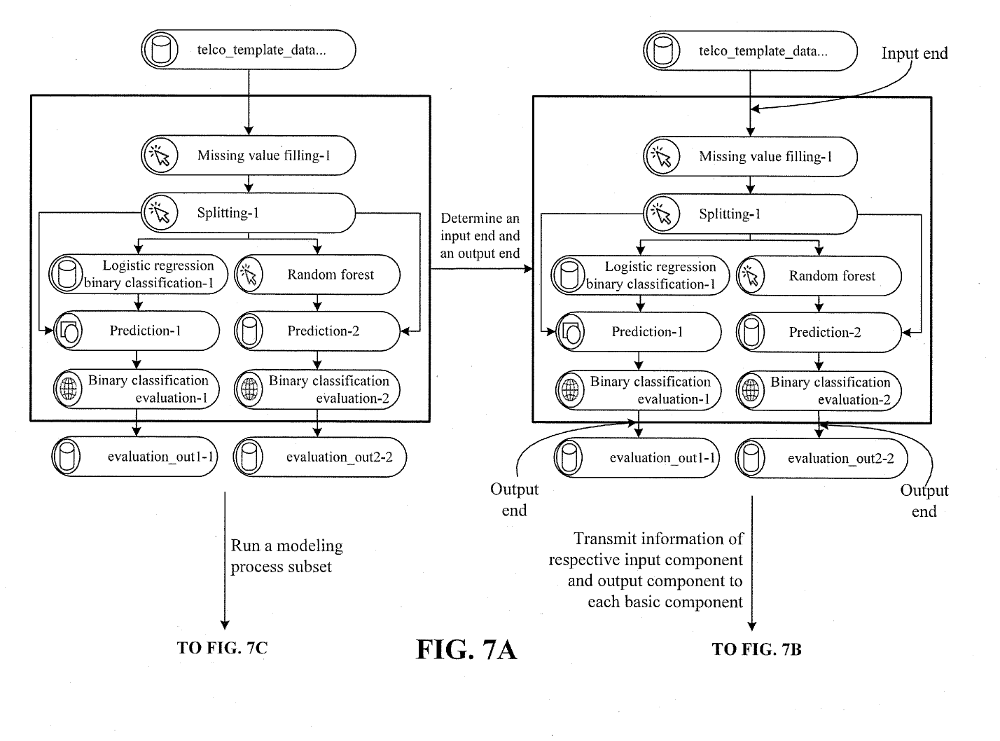

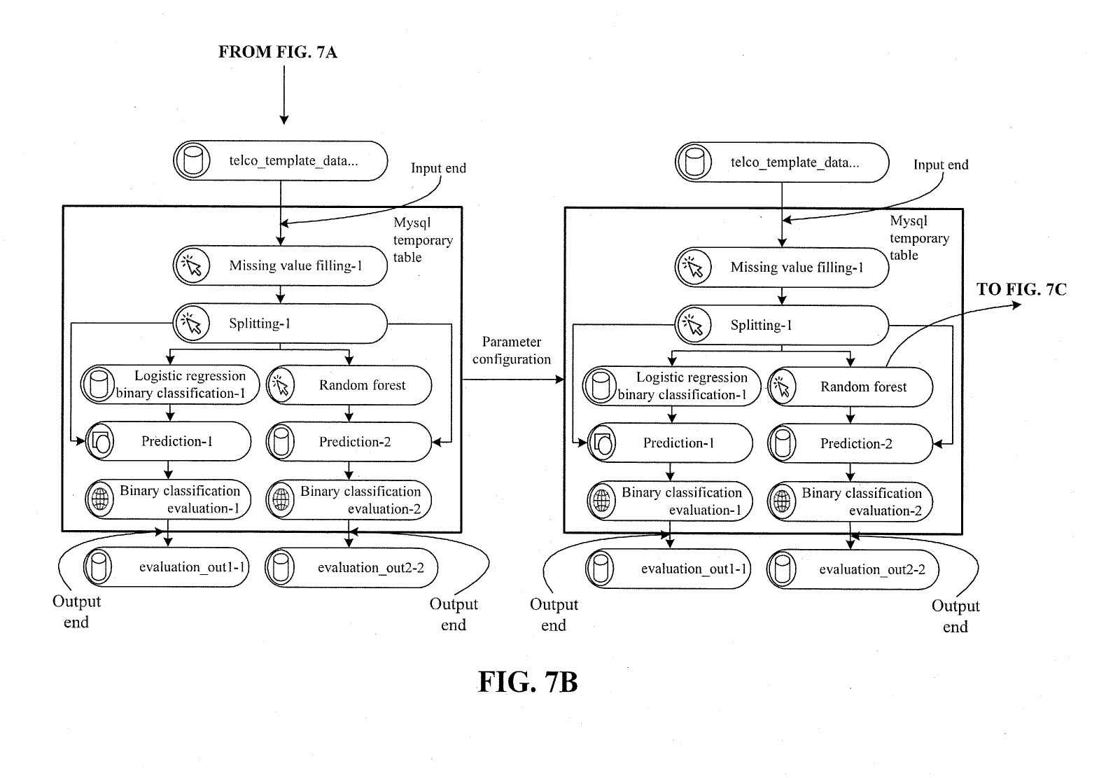

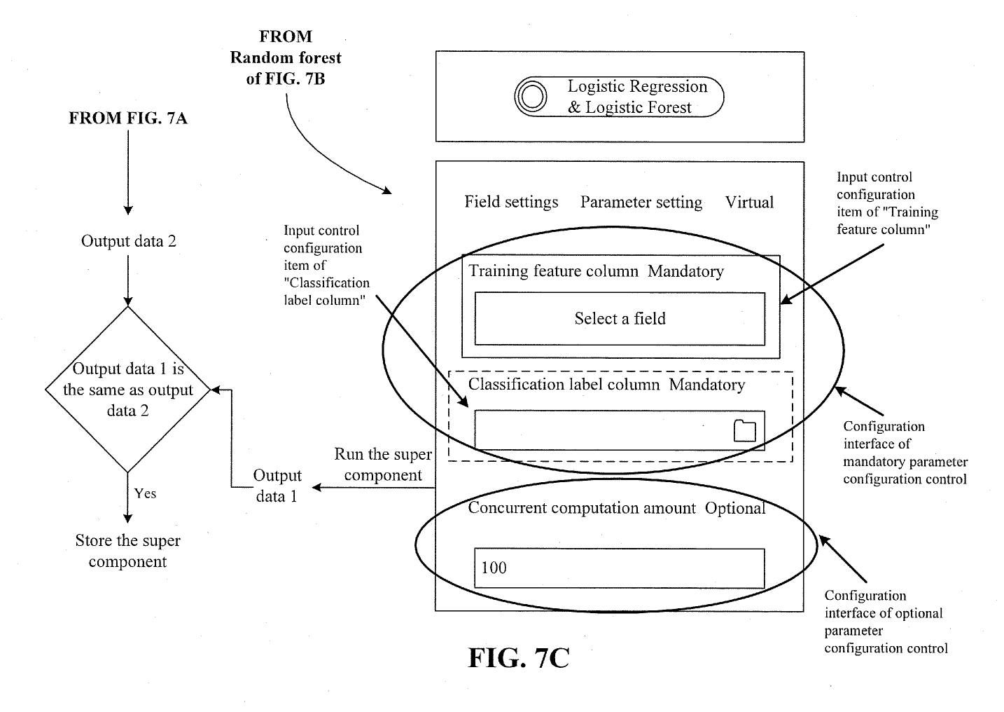

As shown in FIG. 7A, FIG. 7B, and FIG. 7C, a user drags basic components onto a canvas on a graphic machine learning algorithm platform and organizes the basic components with arrows to form a process. The user can select a part from the process, and the user can also right click, select “Merge” in a pop-up menu to merge the selected components to form a modeling process subset, and enter the name “Logistic Regression & Random Forest Evaluation”.

The graphic machine learning algorithm platform uses the port of starting basic component “missing value filling-1” of the modeling process subset, connecting to an upstream component, as the input end of the super component “Logistic Regression & Random Forest Evaluation.” The graphic machine learning algorithm platform also uses the ports of end basic components “binary classification evaluation-1” and “ binary classification evaluation-2” of the modeling process subset, connecting to downstream components, as output ends of the super component “Logistic Regression & Random Forest Evaluation.”

The user clicks on basic component “random forest” in the modeling process subset. As a result, the graphic machine learning algorithm platform pops up the visual interface shown in FIG. 5.

The user completes configuration of the parameter configuration controls on the visual interface.

The graphic machine learning algorithm platform receives parameters input by the user for the super component of which the configuration has been completed, runs the super component, and obtains output data of the super component. The graphic machine learning algorithm platform receives parameters input by the user for the modeling process subset, runs the modeling process subset, and obtains output data of the modeling process subset. If the output data of the super component is the same as the output data of the modeling process subset, the graphic machine learning algorithm platform releases the super component.

At this point, the graphic machine learning algorithm platform has released a new super component. If users desire the function of the modeling process subset, they can use the super component directly without the need of building the modeling process subset again.

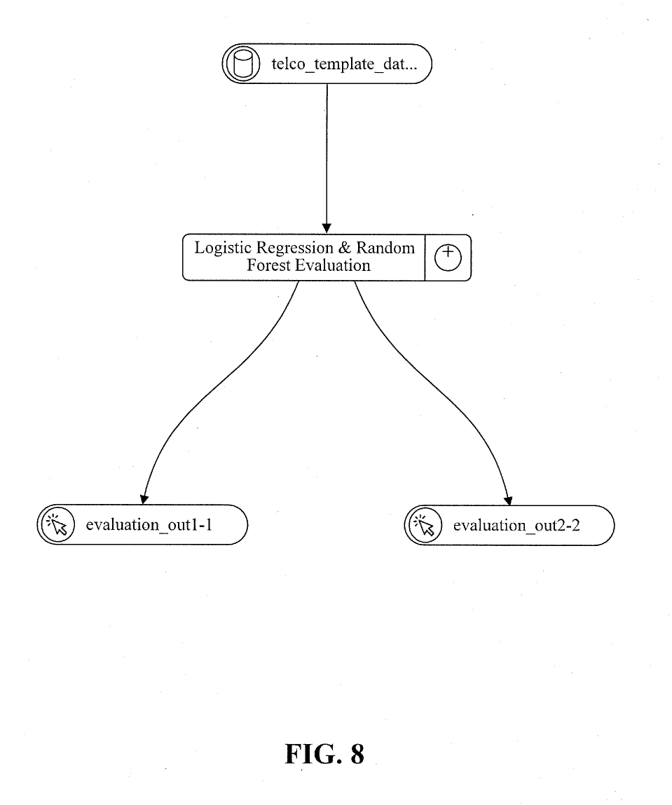

The super component is used in the same way as a basic component. As shown in FIG. 8, a process of using the super component can include that the user drags the super component “Logistic Regression & Random Forest Evaluation” onto the canvas in the graphic machine learning algorithm platform and builds a process with other basic components or super components.

If the user clicks the “Logistic Regression & Random Forest Evaluation” super component, as shown in FIG. 4, the graphic machine learning algorithm platform pops up a parameter configuration control, such as the “training feature column configuration control.” The user selects a field in the “training feature column configuration control” to enter data as a training feature column. After the user configures the data of each parameter, during the running of the super component, the data is input from the input end and transmitted. The data includes values of mandatory parameters of each component in the super component. Each component identifies what part of the data is needed via unique identifiers set for the mandatory parameters during release of the component.

In addition, during the running of the super component, the graphic machine learning algorithm platform establishes a Mysql temporary table according to the directions of the arrows in the super component, for recording an input component and an output component of each basic component, so as to transmit information of the input component and the output component corresponding to each basic component. The content of the Mysql temporary table includes four elements of the component: input, output, field settings, and parameter settings. When the component pointed by the arrow is executed, the four elements can be extracted from the Mysql table. After the super component finishes running, the graphic machine learning algorithm platform clears the Mysql table.

As in the component release process shown in FIG. 2, a unique identifier is set for the mandatory parameter of the basic component by configuring the parameter configuration control of the basic component in the functional model, so that the mandatory parameter can be considered a “global parameter.” That is, during the running of the super component, a basic component in the super component can identify what part of the data is needed as values of mandatory parameters. Therefore, the super component released in FIG. 2 can be used repeatedly, which improves convenience for users.

A graphic machine learning platform-based component creation method is further provided in the embodiments of the present disclosure.

The method can include: after receiving a new component creation instruction, a graphic machine learning platform creates a new component according to an established functional model. A mandatory parameter of each component in the new component has a unique identifier, and the unique identifier is used for the new component to identify the value of the mandatory parameter during running.

In some embodiments, creating a new component according to an established functional model can include: determining unique identifiers of mandatory parameters of components in the functional model, and determining an input and an output end of the new component according to connection relationship of the components in the functional model, so as to create the new component.

After the new component is created, the graphic machine learning platform can release the new component according to a user's instruction. Reference of the component creation method can be made to FIG. 2.

It is appreciated that the graphic machine learning platform is configured to create a new component.

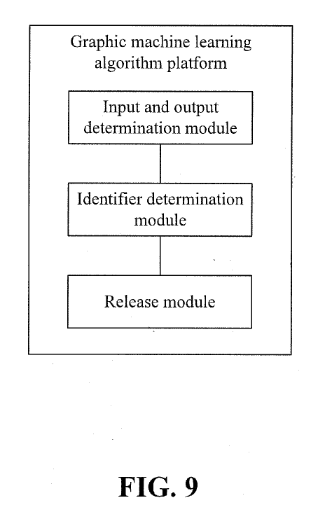

FIG. 9 illustrates a schematic structural diagram of an exemplary graphic machine learning algorithm platform, consistent with embodiments of the present disclosure. The platform can include an input and output determination module, an identifier determination module, and a release module.

The input and output determination module is used for determining, after receiving an instruction to release a functional model as a new component, an input end and an output end of the new component according to connection relationship of components in the functional model. The identifier determination module is used for determining unique identifiers of mandatory parameters of the components in the functional model, wherein the unique identifiers are used for the new component to identify values of the mandatory parameters during running of the new component. The release module is used for releasing the functional model as the new component. Reference can be made to FIG. 2.

The graphic machine learning algorithm platform according to some embodiments of the present disclosure is configured to release a functional model as a new component, and thus can facilitate use by the user.

A graphic machine learning algorithm platform is further provided by some embodiments of the present disclosure. The platform can include a component creation module used for creating, after receiving a new component creation instruction, a new component according to an established functional model, wherein a mandatory parameter of each component in the new component has a unique identifier, and the unique identifier is used for the new component to identify a value of the mandatory parameter during running of the new component. In some embodiments, creating a new component according to an established functional model can include: determining unique identifiers of mandatory parameters of the components in the functional model, and determining an input end and an output end of the new component according to connection relationship of the components in the functional model, so as to create the new component.

It can be seen that the graphic machine learning algorithm platform has according to some embodiments of the present disclosure is configured to create a new component.

In some embodiments, a non-transitory computer-readable storage medium including instructions is also provided, and the instructions may be executed by an apparatus (such as a personal computer, a server, a mobile computing device, or a network device), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It is appreciated that the above descriptions are only exemplary embodiments provided in the present disclosure. Consistent with the present disclosure, those of ordinary skill in the art may incorporate variations and modifications in actual implementation, without departing from the principles of the present disclosure. Such variations and modifications shall all fall within the protection scope of the present disclosure.

1. A component releasing method, comprising:
receiving an instruction to release a functional model as a first component;
determining unique identifiers of mandatory parameters of second components that form the functional model, wherein the unique identifiers are used for the first component to identify values of the mandatory parameters during running of the first component; and
releasing the functional model as the first component.

2. The method according to claim 1, further comprising:
after receiving the instruction to release the functional model as the first component, determining an input end and an output end of the first component according to connection relationship of the second components.

3. The method according to claim 1, wherein determining the unique identifiers of the mandatory parameters of the second components in the functional model comprises:
after receiving an instruction to select one of the second components in the functional model, displaying a visual interface of the one of the second components; and
receiving a unique identifier of a mandatory parameter of the one of the second components through the visual interface.

4. The method according to claim 3, wherein the visual interface comprises:
a configuration interface of a mandatory parameter configuration control of the one of the second components, wherein the mandatory parameter configuration control is used to receive a configuration instruction for the mandatory parameter during the running of the first component.

5. The method according to claim 4, wherein the visual interface further comprises:
a configuration interface of an optional parameter configuration control, wherein the optional parameter configuration control is used to receive a configuration instruction for the optional parameter during the running of the first component.

6. The method according to claim 1, wherein releasing the functional model as the first component comprises:
inputting test data to the first component and running the first component;
inputting the test data to the functional model and running the functional model; and
in response to a determination that data output by the first component after completion of running the first component is the same as data output by the functional model after completion of running the functional model, releasing the functional model as the first component.

7-8. (canceled)

9. An apparatus for component releasing, comprising:
a memory storing a set of instructions; and
one or more processors configured to execute the set of instructions to cause the apparatus to perform:
receiving an instruction to release a functional model as a first component;
determining unique identifiers of mandatory parameters of second components that form the functional model, wherein the unique identifiers are used for the first component to identify values of the mandatory parameters during running of the first component, and
releasing the functional model as the first component.

10. The apparatus according to claim 9, wherein the one or more processors are configured to execute the set of instructions to cause the apparatus to further perform:
after receiving the instruction to release the functional model as the first component, determining an input end and an output end of the first component according to connection relationship of the second components.

11. The apparatus according to claim 9, wherein determining the unique identifiers of the mandatory parameters of the second components in the functional model comprises:
displaying, after receiving an instruction to select one of the second components in the functional model, a visual interface of the one of the second components; and
receiving a unique identifier of a mandatory parameter of the one of the second components through the visual interface.

12. The apparatus according to claim 11, wherein displaying the visual interface of the one of the second components comprises:
displaying a configuration interface of a mandatory parameter configuration control of the one of the second components, wherein the mandatory parameter configuration control is used to receive a configuration instruction for the mandatory parameter during the running of the first component.

13. The apparatus according to claim 12, wherein the visual interface further comprises:
a configuration interface of an optional parameter configuration control, wherein the optional parameter configuration control is used to receive a configuration instruction for the optional parameter during the running of the first component.

14. The apparatus according to claim 9, wherein releasing the functional model as the first component comprises:
inputting test data to the first component and running the first component;
inputting the test data to the functional model and running the functional model; and
in response to a determination that data output by the first component after completion of running the first component is the same as data output by the functional model after completion of running the functional model, releasing the functional model as the first component.

15-16. (canceled)

17. A non-transitory computer readable medium that stores a set of instructions that is executable by at least one processor of a device to cause the device to perform a component releasing method, the method comprising:
receiving an instruction to release a functional model as a first component;
determining unique identifiers of mandatory parameters of second components that form the functional model, wherein the unique identifiers are used for the first component to identify values of the mandatory parameters during running of the first component; and
releasing the functional model as the first component.

18. The computer readable medium according to claim 17, wherein the set of instructions that is executable by the at least one processor of the apparatus to cause the apparatus to further perform:
after receiving the instruction to release the functional model as the first component, determining an input end and an output end of the first component according to connection relationship of the second components.

19. The computer readable medium according to claim 17, wherein determining the unique identifiers of the mandatory parameters of the second components in the functional model comprises:
after receiving an instruction to select one of the second components in the functional model, displaying a visual interface of the one of the second components; and
receiving a unique identifier of a mandatory parameter of the one of the second components through the visual interface.

20. The computer readable medium according to claim 19, wherein the visual interface comprises:
a configuration interface of a mandatory parameter configuration control of the one of the second components, wherein the mandatory parameter configuration control is used to receive a configuration instruction for the mandatory parameter during the running of the first component.

21. The computer readable medium according to claim 20, wherein the visual interface further comprises:
a configuration interface of an optional parameter configuration control, wherein the optional parameter configuration control is used to receive a configuration instruction for the optional parameter during the running of the first component.

22. The computer readable medium according to claim 7, wherein releasing the functional model as the first component comprises:
inputting test data to the first component and running the first component;
inputting the test data to the functional model and running the functional model; and
in response to a determination that data output by the first component after completion of running the first component is the same as data output by the functional model after completion of running the functional model, releasing the functional model as the first component.

23-24. (canceled)
